(19) United States
(12) Patent Application Publication
(10) Pub. No.: US 2026/0089222 A1
(43) Pub. Date: Mar. 26, 2026

(54) SYSTEMS AND METHODS FOR IMPLEMENTING AUTOMATED ONLINE USER NETWORK CURATION

(71) Applicants: Gina Bianchini, Palo Alto, CA (US); Tim Herby, Palo Alto, CA (US); Thomas Aaron, Palo Alto, CA (US)

(72) Inventors: Gina Bianchini, Palo Alto, CA (US); Tim Herby, Palo Alto, CA (US); Thomas Aaron, Palo Alto, CA (US)

(73) Assignee: Mighty Software, Inc., Palo Alto, CA (US)

(21) Appl. No.: 19/339,054

(22) Filed: Sep. 24, 2025

Related U.S. Application Data
(60) Provisional application No. 63/699,576, filed on Sep. 26, 2024.

(51) Int. Cl. H04L 67/306; G06Q 50/00

(52) U.S. Cl. CPC H04L 67/306; G06Q 10/40

(57) ABSTRACT

Systems and methods for implementing automated online user network curation are disclosed. A method can include receiving parameters for custom user networks from a host, where the parameters are used to determine which users to assign to the custom user networks, generating the custom user networks, receiving user information, generating user profiles for each of the users based on the received user information, where the user profiles include profile fields that describe user properties. The method can include determining users to assign to the custom user networks by providing the user profiles and the parameters as input to a pretrained machine learning model, receiving as output from the pretrained machine learning model the user profiles that have profile fields which match the parameters of the custom user networks, and assigning users to the custom user networks based on the determined user profiles that have profile fields that match.

### CROSS-REFERENCE TO RELATED APPLICATIONS

This application claims priority to and the benefit of U.S. Provisional Application No. 63/699,576 titled “Systems and Methods for Implementing Automated Online User Network Curation” and filed Sep. 26, 2024 which is incorporated herein by reference in its entirety.

### TECHNICAL FIELD

The present disclosure generally relates to systems and methods for automated online user network curation, and more specifically, systems and methods for increasing user engagement within the user networks, and/or automating user network management and/or user engagement.

### BACKGROUND

Conventional user networks depend solely on the users of the said networks to manually make connections between the users. The manually made connections are what the conventional user networks are built on. The conventional user networks can also take time to build since they are dependent on the direct interactions between users, e.g., if users are not incentivized to make connections, the user networks can take longer to build. Furthermore, conventional networks may not group together the individuals that may be the best fit for a particular user network. Additionally, the conventional networks can be built on incomplete data, e.g., there are many opportunities to miss out on adding users who may be a good fit for the network that is being built since those users were not known or connected to the users who built the networks.

The foregoing discussion, including the description of motivations for some embodiments of the invention, is intended to assist the reader in understanding the present disclosure, is not admitted to be prior art, and does not in any way limit the scope of any of the claims.

### SUMMARY

Systems and methods for implementing automated online user network curation are disclosed. In some embodiments, the method can include a method for automatic assignment of users to custom user networks. In some examples, the method can include receiving, at a computer system comprising a processor and a memory storing instructions executable by the processor, parameters for the custom user networks from a host of the computer system, where the parameters are used to determine which users to assign to the custom user networks. The method can include generating, by the processor, the custom user networks. The method can include receiving, at the computer system, user information from users of the computer system. The method can include generating, by the processor, user profiles for each of the users based on the received user information, where the user profiles include profile fields that describe properties of the users. The method can include determining users to assign to the custom user networks by providing, by the processor, the user profiles and the parameters as input to a pretrained machine learning model, and receiving as output, by the processor, from the pretrained machine learning model the user profiles that have profile fields which match the parameters of the custom user network. The method can include assigning, by the processor, users to the custom user networks based on the determined user profiles that have profile fields matching the parameters of the custom user networks.

Various embodiments of the method can include one or more of the following steps.

In some embodiments, the profile fields can include at least one of a user's skills, a user's name, a user's birthday, a user's age, a user's address, a user's occupation, a user's specialization, a user's education, or a user's certifications. In some examples, receiving user information from the users can include receiving, at the computer system, user information as prompts to a large language model (LLM). Generating, by the processor, user profiles for each of the users based on the collected user information can include generating, by the processor, a structured dataset for each of the users that includes the user information associated with each user. Generating, by the processor, user profiles for each of the users based on the collected user information can include using a LLM to generate the user profiles based on the collected user information received from the users as a prompt. Receiving, by the computer system, parameters for custom user networks from the host can include receiving, at the computer system, keywords used to determine which users to assign to the custom user networks. Receiving, by the computer system, parameters for custom user networks from the host can include receiving, by the computer system, parameters as prompts to a LLM. Determining users to assign to the custom user networks can include the pretrained machine learning model clustering and segmenting the user profiles based on their corresponding profile fields and the parameters of the custom user networks. Assigning the users to the custom user networks can include using a LLM to automatically assign users to the custom user networks based on the determined user profiles that have profile fields matching the parameters of the custom user networks.

In some embodiments, the method can include (i) receiving, at the computer system, tag parameters from the host, wherein the tag parameters are used to determine unique characteristics of the users, (ii) determining users having unique characteristics by providing, by the processor, the user profiles and the tag parameters as input to a pretrained machine learning model, and receiving as output, by the processor, from the pretrained machine learning model the user profiles that have profile fields which match the tag parameters, and (iii) assigning, by the processor, tag identifiers to the user profiles having profile fields which match the tag parameters, wherein the tag identifiers are only visible to the hosts. In some examples, the method can include (i) receiving, at the computer system, badge parameters from the host, where the badge parameters define a user activity of the users to track, (ii) tracking, by the processor, the user activity of the users defined by the badge parameters, (iii) determining, by the processor, the users that performed the user activity based on the tracked user activity and the badge parameters, and (iv) assigning, by the processor, badge identifiers to the user profiles of the users that performed the user activity, wherein the badge identifiers are visible to all users and hosts.

A method for collecting user information from users of a plurality of user networks is presented. The method can include generating user profiles for each of the users based on the collected user information. The method can include receiving user network parameters from hosts, where the user network parameters can include attributes that describe at least one user network of the plurality of user networks. The method can include selecting at least one user profile that has profile fields that match the attributes of the user network parameters. The method can include assigning at least one user to the at least one user network based on the selected user profile that matches the user network parameters.

Various embodiments of the method can include one or more of the following steps.

In some embodiments, collecting user information can include collecting at least one of a user's skills, a user's name, a user's birthday, a user's age, a user's address, a user's occupation, a user's specialization, a user's education, or a user's certifications. In some examples, collecting user information from users can include receiving user information as prompts to a large language model (LLM). Generating user profiles for each of the users based on the collected user information can include generating a structured dataset for each of the users that can include the user information associated with each user. Generating user profiles for each of the users based on the collected user information can include using a LLM to generate the user profiles based on the collected user information received from the users as a prompt. Receiving network parameters from hosts can include receiving network parameters including user-specific attributes for assigning users to the at least one user network. Receiving user network parameters from hosts can include receiving network parameters as prompts to a LLM. Selecting at least one user profile can include using a LLM to determine the at least one user profile that has profile fields that match the attributes of the user network parameters. Assigning at least one user to the at least one user network can include using a LLM to automatically assign the at least one user to the at least one user network.

A system for implementing automated online user network curation is presented. The system can include a segmentation component that (i) receives instructions from a host of the system, wherein the instructions include parameters for users networks of the system, (ii) receives user information from users of the user networks, (iii) generates user profiles having profile fields for each of the users based on the collected user information, and (iv) determines which users to assign to the user networks based on the profile fields which match the received parameters for users networks. The system can include an automation component that assigns users to the user networks based on the determined user profiles that have profile fields which match the parameters of the user networks. The system can include a dynamic experiences component that presents the users with their respective assigned user networks.

Various embodiments of the system can include one or more of the following features.

In some embodiments, the user information can include at least one of a user's skills, a user's preferences, a user's name, a user's birthday, a user's age, a user's address, a user's occupation, a user's specialization, a user's education, or a user's certifications. In some embodiments, the segmentation component determines users to assign to the user networks by providing the user profiles and the parameters as input to a pretrained machine learning model, and receives as output from the pretrained machine learning model the user profiles that have profile fields which match the parameters of the user networks. The segmentation component can generate a structured dataset for each of the users that can include the user information associated with each user. The segmentation component can generate user profiles using a LLM based on the collected user information received from the users as a prompt. The automation component can include a LLM that assigns users to the user networks based on the determined user profiles that have profile fields which match the parameters of the user networks. The dynamic experiences component can include a LLM that presents the users with their respective assigned user networks.

### BRIEF DESCRIPTION OF THE DRAWINGS

The accompanying figures, which are included as part of the present specification illustrate the presently preferred embodiments, and together with the general description given above and the detailed description of the preferred embodiments given below, serve to explain and teach the principles described herein. Furthermore, like reference numbers refer to similar or the same components within the figures.

FIG. 1 illustrates a block diagram of a system for user network curation, according to some embodiments.

FIG. 2 illustrates a flowchart of a method for user network curation, according to some embodiments.

FIG. 3 illustrates a flowchart of a method for user network curation, according to some embodiments.

FIG. 4 illustrates a flowchart of a method for user network curation, according to some embodiments.

FIG. 5 illustrates a flowchart of a method for automatic assignment of users to custom user networks, according to some embodiments.

FIG. 6 illustrates a flowchart of a method for assigning an identifier to a user profile, according to some embodiments.

FIG. 7 illustrates a flowchart of a method for assigning an identifier to a user profile, according to some embodiments.

FIG. 8 illustrates a diagram of an exemplary hardware and software systems implementing the systems and methods described herein, according to some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

Systems and methods for automated online user network curation are disclosed. In some embodiments, the systems and methods presented herein can be configured to automatically manage actions and tasks associated with the user networks, increase user engagement within the user networks, and automate user network management and/or user engagement, among other actions.

In some embodiments, the systems and methods presented herein can be used to automatically provide assistance with user network curation and/or user engagement with the user networks. The systems and methods presented herein can use automated workflows and/or artificial intelligence (AI) algorithms (referred to herein as AI) to determine each user's skillset, and/or characteristics. For example, the systems and methods presented herein can use automated workflows and/or AI algorithms to determine user skillsets, and/or user characteristics that have relevance to particular user networks. The systems and methods can determine (i) which users to connect, (ii) why the users should be connected, (iii) when to initiate the connection, and/or (iv) where to prompt future engagement (e.g., for location based user networks). In some examples, determining (i)-(iv) can be based on the user information such as user skillsets, user properties, and/or user characteristics that have relevance to particular user networks.

In some embodiments, the systems and methods presented herein can be configured to assist host users, e.g., referred to herein as hosts, to invite users to join, to manage, and/or to create particular user networks. In some examples, the hosts can provide input parameters to the system for generating one or more user networks for grouping together users having particular skillsets, properties and/or characteristics. In one example, the system can be configured to generate custom user networks, e.g., which are a subset of a superset user network that makes up the entire might system. The system can be configured to generate custom user networks based on input parameters and/or prompts provided by the hosts. The custom user networks can be tailored to a particular use case of the hosts. In some embodiments, the custom user networks can be directed toward grouping together users with shared interests in education, learning, crafting, business, hobbies, occupations, among others. In some examples, the system and methods presented herein can be configured to assist the host in performing one or more actions, e.g., teaching online courses, holding online classes, seminars, facilitating group activities, among other actions. The system and methods can be configured to assist the host to reach more users, grow the user base of the user networks, and engage with the users. The systems and methods can go a step further by providing each host with the capability to customize how each user network is ordered, segmented, and/or organized. The systems and methods can go a step further by providing each host with the capability to customize how engagement with each user of the custom user networks is performed. In some examples, the host can provide the system with instructions, e.g., in the form of input parameters and/or prompts, to implement particular automation and/or dynamic experiences for encouraging participation among the users in the custom user networks. The hosts can assign identifiers to particular users having certain profile fields and/or that have performed a particular activity within the system. In some embodiments, the hosts can assign a tag to users having certain profile fields. In some examples, the hosts can provide instructions to the system to assign the tag users having a profile field of “occupation” including the data “musician”. Based on this, the system can automatically tag all users with the corresponding profile fields. In some embodiments, the hosts can add a badge to users having performed a particular user activity. In some examples, the hosts can provide instructions to the system to assign a badge to the users having logged into the system consecutively for 5 days in a week. The tags can include identifiers visible only to hosts, and the badges can include identifiers visible to all users within the system.

In some embodiments, the systems and methods provide improvements over other user networks or services by automating user connections to build more value and engagement for each user of the online user networks. Each host can customize segmentation that drives user engagement and can therefore be unique to each network. In some examples, in contrast to the systems and methods presented herein, other systems can depend on the users themselves to manually make one-on-one connections to build connections with other users. Manually connecting users can be time consuming, are dependent on the community itself, and may not group together the most optimized individuals based on the user's strengths or skillsets. Manual built user groups may also be built on flawed assumptions, e.g., missing data. For example, certain users may not be added to a particular user network because the users that could be added are not known to the users of the user network. In some examples, the users of the user network are unaware that the particular users that may have a skillset which can enrich, benefit, or be a good fit for the network. Furthermore, unlike other systems, the systems and methods presented herein can automatically engage users and/or provide assistance to hosts when engaging and/or providing services to the users of the user network. As used herein, the systems presented herein can be referred to as a mighty system and/or a people magic system.

As described herein, a user can be represented by a computer account and/or user profile associated with a person who uses or utilizes the mighty network. For example, the user can be identified by the mighty network via user account credentials, and/or user profiles associated with the user. The user credentials, and/or user profiles include information that describes the user.

As described herein, a host can be represented by a computer account and/or user profile associated with a person who manages user networks within the system. The host can include a person with administrative privileges to manage, control and/or access the user networks. The host can be identified by the mighty network via account credentials, and/or user profiles associated with the host. The host can include host user credentials, and/or host user profiles. The host user credentials and/or host user profiles can include information that describes the host.

As described herein, a user network can include a collection and/or grouping of user accounts, user profiles, among others, collected and/or associated together via one or more computer networks and/or services. For example, the user networks can include a collection of user profiles. In some examples, the user networks can include a landing page, and/or a shared online space (e.g., webpage, website) where the users can connect and/or communicate with similarly associated user accounts and/or user profiles. For example, the users can be grouped together within a user network based on user information associated with and/or describing the users on the user network. The user information can include profile fields that contain keywords. Users with similar and/or the same profile fields, in one example based on matching keywords, can be automatically grouped together under the same user network. In some examples, users can be sent invites to join user networks that include parameters which match the profile fields of their corresponding user profiles. In one example, the user information that describes the users can be included within the user credentials and/or user profiles. The user network can include and/or be integrated into computer networks and/or services. The user network can be referred to as an online user group, a user group, a member network, an online user network, a mighty user network, mighty network, a user account database, a user profile database, among other terms.

Thus, technical solutions for automatically onboarding users, increasing user engagement, and/or automating user engagement for user networks running on online computer systems are disclosed. An exemplary network, e.g., a system 100, that is configured for automatic curation and/or user engagement, among other actions, is described in further detail below.

### System for User Network Curation

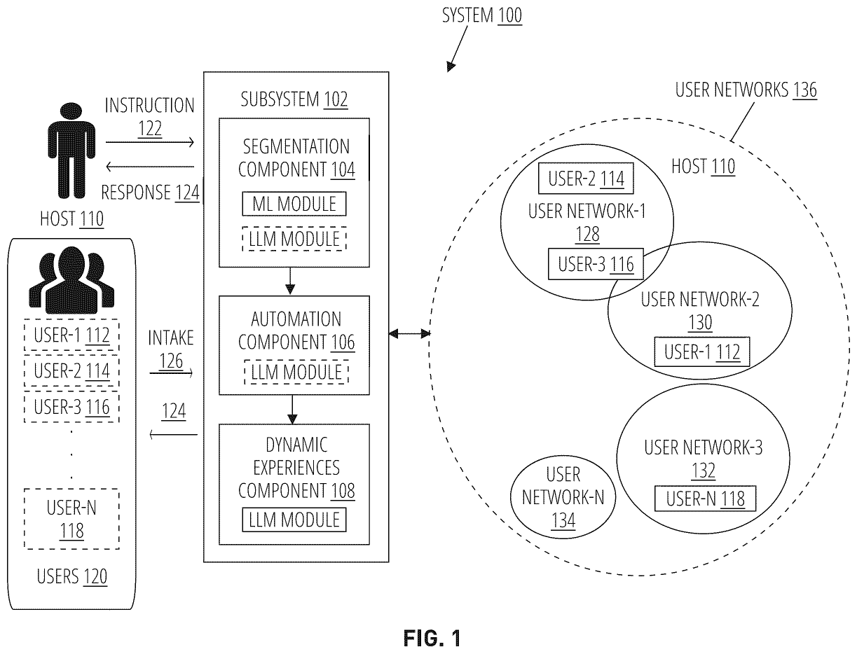

Referring to FIG. 1, a block diagram of a system 100 for user network curation is shown, according to some embodiments. In some embodiments, the system 100 can be implemented via computer programs loaded onto computers, computer networks, and/or on the cloud. In some embodiments, the system 100 can include a subsystem 102, hosts 110, users 110-118 (collectively referred to herein as users 120), and/or user networks 128-134 (collectively referred to herein as user networks 136), among other components. In some examples, the system 100 can be configured to automatically manage user networks 136, and increase user engagement with each of the users 120 of the user networks 136, among other actions. The user networks 136 can include introducing members, e.g., users, of the user networks 136 to each other via chat, one-on-one chat, group chat, channels in a network (e.g., spaces), events, and cohort courses. Hosts 110 can include administrative users 120 of the system 100. The hosts 110 include a professional that would like to build a community and/or service on the system 100. The users 120 can include a target audience and/or user base the hosts 110 are looking to cater to for their respective system 100. The user networks 136 can be associated with a host 110. Corresponding user networks 136 assigned to the host 110, can be limited to that host 110. The host 110, via the subsystem 102, can limit access to their associated user networks 136. The host 110 can grant access to their associated user networks 136 to other hosts 110.

In some embodiments, the system 100 can be configured to automatically curate the user networks 136 and/or curate the user networks based on input parameters and/or instructions provided by the hosts. In some examples, the system 100 can automatically perform the curation and/or implement curation based on input parameters and/or instructions provided by the hosts. In one example, the system can assist the hosts 110 in the curation of the user networks 136. For example, the hosts 110 can initiate the creation of the user networks 136 by transmitting and/or submitting a command, input parameters, and/or a prompt to the subsystem 102. The hosts 110 can input parameters and/or commands via logging onto a website and/or using an application. The hosts 110 can provide a framework, e.g. in the form of input parameters, for the user networks 136 to be generated. In one example, the system can be configured to generate user networks 128, 130, 132, 134 which can be a subset of the user network 136. In some examples, the user networks 128-134 can also be referred to herein as custom user networks. The subsystem 102 can include a computer program loaded onto a single computer, a network of computers, on the cloud, among others. The subsystem 102 can be configured to receive the instructions 122 from the hosts 110 on behalf of the system 100, e.g., via a website and/or application. The instructions 122 can include parameters and/or prompts received from the hosts 110. The subsystem 102 can generate the user networks 136 based on the received instructions 122. In some examples, the subsystem 102 can generate custom user networks, e.g., including the user networks 128-134, based on the received instructions. The subsystem 102 can be configured to intake 126 users 120 of the system 100. For example, the intake 126 can include the subsystem 102 requesting, collecting, and/or receiving user information from the users 120. The user information can include user skills, user preferences within the system 100, user background, among other user information that describes particular characteristics of the users. In some examples, the user information can include the user's username, name, birthday, age, address, occupation, specialization, skills, special skills, education, certifications, skillsets, customer relationship management (CRM) data, memberships within the user network 136, physical location, posts within the user network 136, preferences within the system 100, comments within the user network 136, sentiment within the user network 136, use of the system 100, reactions within the user network 136, among other user information. The subsystem 102 can generate a user account and/or user profile that is associated with each of the users 120 of the system 100. The subsystem 102 can use the user information to assign the users 112-118 to particular user network of the user networks 136. The 102 can generate user profiles for each of the users 120 based on the received user information, where the user profiles include profile fields that describe properties of the users 120. The subsystem 102 can determine users 120 to assign to the custom user networks by providing the user profiles and the parameters received from the host 110 as input to a pretrained machine learning model of the subsystem 102. The pretrained machine learning model can output the user profiles that have profile fields which match the parameters of the custom user network. The subsystem 102 can assign users 120 to the custom user networks based on the determined user profiles that have profile fields matching the parameters of the custom user networks. In some examples, the subsystem 102 can (i) determine user network parameters of the user networks, (ii) determine user profiles having profile fields that match the user network parameters, (iii) select the user profiles having matching user profile fields, and (iv) assign the selected user profiles to user networks based on the matching user profile fields and user network parameters. If no user networks 136 are pre-generated, and/or depending on instructions 122 received from the hosts 110, the subsystem 102 can create the user networks 136 and subsequently place the users into user networks 136. As described herein, the instructions 122 can include keywords used to determine which users 120 to assign to the custom user networks.

In some embodiments, the system 100 can include automated workflows to query users to determine characteristics that describe the users, and based on the responses of the users, generate the user information. In some examples, the system 100 can make use of AI algorithms, e.g., machine learning (ML) models, large language models (LLMs), to query the users and receive their responses. The AI algorithms can generate the user information based on the received user responses. In some embodiments, the subsystem 102 can include the AI algorithms. In some examples, the subsystem 102 can use LLMs to generate the corresponding user profiles having profile fields from the user information. In one example, the LLMs of the subsystem 102 can generate the user profiles based on the collected user information received from the users 120 via a questionnaire, form field, and/or as a prompt. In an example, the LLMs of the subsystem 102 can generate the user profiles based on the collected user information received from the users 120 during intake 126.

In some embodiments, based on the user information, the system 100 can automatically determine which users to assign to the user networks 136. In some examples, for user-1 112, the subsystem 102 can determine that the user-1 112 has a skillset, characteristics and/or user preferences that are appropriate and/or beneficial for user network-2 130. For example, for user-1 112, the subsystem 102 can determine that the user-1 112 has a corresponding profile field that matches a parameter for user network-2 130 and can assign user-1 112 to the user network-2 130. The subsystem 102 can determine that user-1 112 can be assigned to the user network-2 130 by providing a user profile of the user-1 112 and parameters of user network-2 130 as input to a pretrained machine learning model of the subsystem 102, e.g., using the ML model associated with the segmentation component 104 of the subsystem 102. The pretrained machine learning model can output the user profiles that have profile fields which match the parameters of the user network-2 130. The subsystem 102 can assign user-1 112 to the user network-2 130 based on the output of the pretrained machine learning model. The subsystem 102 can make a similar determination for user-2 114 and user-3 116, e.g., determining that both user-2 114 and user-3 116 would be optimally placed at user network-1 128. The nth user, user-N 118 can also be placed under user network-3 132 in a similar manner. The subsystem 102 can further be guided by instructions 122 from the hosts 110. Alternatively, the hosts 110 can control and/or initiate the placement of each of the users 120 to each of the user networks 136 more directly. For example, the subsystem 102 can provide recommendations (e.g., based together on the user information, user profiles, instructions 122 from the hosts 110) where to optimally place each of the users 120.

### The Subsystem

Referring to FIG. 1, a block diagram of a subsystem 102 is shown, according to some embodiments. In some embodiments, the subsystem 102 a segmentation component 104, an automation component 106, a dynamic experiences component 108, among other components. Each of the components 106-108 can be configured to perform one or more actions. In some examples, the subsystem 102 can include an application running on a server that has a segmentation component 104, an automation component 106, a dynamic experiences component 108, among other components. Each function for each of the components 104-106 is described in detail below.

### The Segmentation Component

Referring to FIG. 1, the subsystem 102 can include the segmentation component 104 as shown, according to some embodiments. In some embodiments, the segmentation component 104 can be used to determine users 120 to assign to the user networks 128-134. In an embodiment, the segmentation component 104 can be used by the subsystem 102 to collect additional user information, e.g., on top of the user information gathered at intake, about the users 120 within the system 100. In some examples, the segmentation component 104 can collect user information that describes the user's actions, behaviors and/or preferences after the intake 126 of the users 120 has been completed. The additional collected information can include information collected using tags, badges, and/or user profile fields. The additional collected user information can include inferred behavioral information observed and/or recorded from the users 120. As referred to herein, the segmentation component 104 can also be referred to as a member segmentation component, a segmentation module, a collection module, among other terms.

Unlike other software services that offer one-on-one matching (e.g., such as dating applications), or conventional customer relationship management systems, the segmentation component 104 can be guided by input from the hosts 110 when placing users 120 into the user networks 136. Therefore, the application of member segmentation using the segmentation component 104 can provide unique customizations and/or use cases which can be defined by the hosts 110. This is in contrast to other systems which are only built on pre-defined segments or characteristics. In some embodiments, the segmentation component 104 includes a pretrained machine learning (ML) model. In some examples, the segmentation component 104 of the subsystem 102 can use and/or include a machine learning segmentation algorithm that is uniquely tailored to each of the user networks 136 (e.g., user networks 128-134) of the host 110 based on the implementation of the system 100 and/or customizations (e.g., input parameters) received and/or implemented by the hosts 110. In some examples, the machine learning segmentation algorithm includes the pretrained machine learning model. In some embodiments, the subsystem 102 determines users 120 to assign to the user networks 128-134 by providing user profiles corresponding to the users 120 and parameters corresponding to the user networks 128-134 as input to the segmentation component, and receiving as output, from the segmentation component, the user profiles that have profile fields which match the parameters of the user network 128-134.

In some embodiments, the tags associated with each of the users 120 can be visible only to hosts 110. In some examples, the tags can be used to define, and document user characteristics that matter and/or are important to the hosts 110 of the system 100. In one example, a host 110, via the segmentation component 104, can apply a tag to a user 120 who has a certain profile field such as job title, is at risk of losing their current job, lives in a specific geographical area, etc. In some examples, applying a tag to the users 120 can include adding and/or assigning an identifier to the user profiles of the users 120. The identifier can include a characteristic that is common among users of a particular user network. In some embodiments, the tags can include identifiers and/or data fields that are added to and/or associated with user profiles of the users. In some examples, the tags can include identifiers only visible to the host 110 and/or specific users the host 110 provides access and/or visibility to the tags. In one example, the tags can be unique identifiers and/or labels which are added to the user profiles. The hosts 110 can create unique experiences for individual users 120 tagged with specific attributes relevant to their assigned user network 136. The specific attributes can be assigned and/or added to the user profiles of the users 120. The subsystem 102 can provide responses 124 to the hosts 110 and the users 120. In some examples, the subsystem 102 can provide responses 124 about the users 120 to the hosts 110 via rich data segmented by tags. For example, the subsystem 102 can respond 124 by presenting data to the hosts 110 and users 120. The subsystem can provide responses 124 via a graphical user interface on a website and/or on an application, e.g., the website or application called Mighty Insights™. In some examples, the tags can represent user information related to user revenue and/or user engagement. The hosts 110 can use the received user information, e.g., tracked via the tags, to determine revenue and/or engagement by user segments defined by the tags. In some embodiments, the segmentation component 104 can receive tag parameters from the hosts 110. The tag parameters can include keywords and/or profile fields that the hosts 120 are interested to identify and/or tag. The tags can be used to determine unique characteristics of the users 120. The segmentation component 104 can determine users 120 having unique characteristics by providing user profiles corresponding to the users 120 and the tag parameters as input to the segmentation component 104, and receiving as output, the user profiles that have profile fields which match the tag parameters.

In some embodiments, the badges associated with each of the users 120 can be assigned to any user in the system 100. The badges can be used, e.g., via the segmentation component 104, to indicate a specific achievement, milestone, and/or actions taken by a particular user in addition to general segmentation purposes. In some embodiments, the badges can include identifiers and/or data fields that are added to and/or associated with user profiles of the users. In some examples, the badges can include identifiers that are public. The badges can include an identifier that represents the successful completion of a specific action, an achievement, and/or having completed a particular milestone on the system 100. The badges can be assigned and/or added to the user profiles once the user completes a task and/or action on the system 100. In some examples, the badges are viewable by other users, e.g., not just by the hosts 110, within the system 100. The badges can include visualizations. In some examples, the badges can be visual in nature, and/or can be customized to each of the users 120 and/or customized to each of the user networks 136. In some examples, the hosts 110 can define custom branding and/or visuals relevant to the network via the badges. In some embodiments, the segmentation component 104 can receive badge parameters from the hosts 110. The badge parameters can define a user activity of the users 120 that the hosts 120 are interested to track. The badges can be used to identify users 120 that have performed a particular user activity within the system 100.

In some embodiments, the user profiles can include profile fields associated with each of the users 120. The user profile fields can include general user profile fields, custom profile fields, among other profile fields. In some examples, the user profile fields can include the user's username, name, birthday, age, address, occupation, specialization, skills, special skills, education, certifications, skillsets, customer relationship management (CRM) data, memberships within the user network 136, physical location, posts within the user network 136, preferences within the system 100, comments within the user network 136, sentiment within the user network 136, use of the system 100, reactions within the user network 136, among other user information. In some examples, custom profile fields can include one or more free-form fields that are definable by the hosts 110. The custom profile fields can accept rich segmentation parameters which can be defined by the hosts 110, and which can be entered by the users 120 (e.g., upon intake 126). The custom profile fields can be both public (e.g., visible by all users 120) and/or private (only visible by hosts 110). In some examples, the custom fields can be implemented via dropdown menus (e.g., accessible on a website of the system 100), open text fields, and/or form fields, among others. In some examples, the dropdown menus can be implemented within website questionnaires and/or forms. The dropdown menus can allow the hosts 110 to define a list of pre-set characteristics for the users 120 or hosts 110 to choose from when completing the questionnaires and/or forms. In one example, dropdown menus can be unlimited to and/or unique to each system 100. The hosts 110 can have an unlimited number of dropdown custom fields implemented, e.g., based on the customizations the hosts 110 are implementing for each individual user network of the user networks 136. In some examples, the increasing the number of segmentation characteristics provided to the subsystem 102 and gathered by the segmentation component 104 can help customize individual user network experiences and make the experiences unique for each of the user networks 136. In an example, the segmentation characteristics can be included within instructions 122 received from the hosts 110.

In some embodiments, open text fields can be used to allow users and/or hosts to request information describing themselves or other users. In some examples, the open text fields associated with each of the users 120 can be similar to a prompt where hosts 110 or users can write free-form responses to an inquire about themselves, their membership, or any other user information relevant to the system 100. In some examples, the open text field can include a custom field. In some examples, the open text field can be used to inform segmentation component 104 and/or the dynamic experiences component 108 of the system 100. The subsystem 102 can be configured to parse smaller text strings and/or single words from the open text fields to segment users and/or create user experiences that are adapted to enhancing and/or optimizing user engagement.

In some embodiments, the user's responses to the questionnaires and/or forms can automatically be recorded as custom fields for each user 120 of the system 100. In some examples, the hosts 110 can utilize a form to collect information about a particular user 120, e.g., user-1 112, when they sign up (e.g., at intake 126) to the system 100 and are assigned a particular user network. In some examples, user-2 114 can be placed under user network-2 130. In some examples, forms can incorporate both dropdowns and/or open text fields. In some examples, forms can be systematically collected via the segmentation component 104 and the user information can be collected by the hosts 110 anytime. In some embodiments, the segmentation component 104 can be configured to provide segmentation of user information that can allow for each system 100 to be unique from one another. The segmentation component 104 can be configured to allow for the creation of an unlimited number of data fields for intake 126 by the hosts 110 and/or allow the hosts 110 to have specificity over the user information, e.g., via the tags, badges, etc., they request for the users 120.

In some embodiments, the segmentation component 104 can include an optional LLM. In some examples, the optional LLM can receive the user information from the users 120 and/or the instructions 122 from the hosts as prompts. The LLM can generate the user profiles based on the collected user information. The LLM can receive parameters for the user networks 136 from the hosts 110.

### The Automation Component

Referring to FIG. 1, the subsystem 102 can include the automation component 106 as shown, according to some embodiments. In some embodiments, the automation component 106 can be used by the subsystem 102 to receive instructions 122 from the hosts 110 and to perform custom actions, referred to herein as workflows. In some examples, the automation component 106 can provide workflows that can be used by the hosts 110 for providing automated instructions 122 to the subsystem 102. In some embodiments, the workflows can include instructions that the subsystem 102 can automatically perform. The workflows can include no-code workflows the hosts 110 can submit via the website of the system 100. No code workflows can include instructions that are closer to human language, e.g., less close to machine programming languages. The no-code workflows can manipulate and/or provide instructions to the subsystem 102 without having to learn a specific programming language. The no-code workflows can reduce the amount of time it would take a host 110 to instruct the subsystem 102, e.g., in comparison to having to learn a programming language before instructing the subsystem 102. In some embodiments, the automation component 106 can allow the hosts 110 to customize and/or reduce the effort in administering user networks 136, and/or reduce the amount of time to create unique experiences for the users 120 based on the use case of user networks 136. As described herein, workflows can be referred to as automations, automated workflows, among other terms. In one embodiment, the automation component 106 can include custom functions such as if-then-else statements that receive the instructions 122 from hosts 110, and perform actions, e.g., the workflows, based on the received instructions 122. In some embodiments, the automation component 106 can be configured to receive the instructions 122, format the instructions 122 for input to a LLM, and input the formatted instructions 122 to the LLM as a prompt. The LLM can perform the actions and/or workflows based on the received formatted instructions 122. In some embodiments, the automation component 106 can include the LLM, and in another embodiment the LLM is optional. In one embodiment, the LLM can be external to the automation component 106, e.g., external to the automation component 104 and/or subsystem 102, and the automation component 106 can instead submit the formatted instructions 122 to the external LLMs. In some examples, the automation component 106 can assign users 120 to the user networks 128-134 based on the determined user profiles that have profile fields matching the parameters of the custom user networks. The automation component 106 can assign tag identifiers to the user profiles of the users 120 having profile fields which match tag parameters, where the tag identifiers are only visible to the hosts 110. The automation component 106 can assign badge identifiers to the user profiles of the users 120 that performed a particular user activity, where the badge identifiers are visible to all users 120 and hosts 110.

In some embodiments, the automation component 106 can include triggers and actions that are used for implementing workflows. For example, step-by-step instructions from the hosts 110 can be implemented by the automation component 106 using the appropriate triggers and actions. In some examples, once a trigger is initiated, a corresponding action can take place automatically. In one example, a triggered action could send a direct message to and/or assign a tag, a badge, custom field to one or more users 120. The triggers and/or actions can be customizable based on system 100 unique segmentation and/or multi-featured space architecture, triggers, and actions to create proprietary data used to create dynamic experiences unique to each system 100. In some examples, the automations via the automation component 106 can be used to promote engagement on a one-on-one basis (e.g., direct messaging), one-to-several basis (e.g., group messaging), and/or one-to-many basis (e.g., community-wide messaging).

In contrast to other no-code software implementations and/or providers, the no-code automations of the automation component 106 can be configured to navigate users 120 towards experiences that enrich the user networks 136 that can grow the overall user base or community of the user networks 136 and help with engagement. In one example, an automation of the automation component 106 can be used to trigger an introduction between users 120, trigger an invitation to a space or membership that one or more users 120 may not have access to, assign segmentation to the user networks 136, and/or send an event invitation to the users 120 of the user networks 136, among other actions. In some examples, automation component 106 can be used together with the segmentation component 104 and the dynamic experiences component 108 to automatically manage user networks, increase user engagement within the user networks, and automate user network management.

### The Dynamic Experiences Component

Referring to FIG. 1, the subsystem 102 can include the dynamic experiences component 108 as shown, according to some embodiments. In some embodiments, the dynamic experiences component 108 can be used by the subsystem 102 to provide seamless and/or automated delivery of user experiences to the users 120 of the user networks 136. In some examples, the dynamic experiences component 108 can be configured to work with the segmentation component 104 and the automation component 106 to provide and/or automatically deliver the user experiences. The dynamic experiences component 108 can be guided and/or informed by both the segmentation component 104 and the automation component 106. In some embodiments, user experiences can include actions and/or functions that the subsystem 100 can perform on behalf of the users 120. As described herein, user experiences can be referred to as user experiences, dynamic experiences, among other terms. The dynamic experiences component can include an AI algorithm. In some examples, the dynamic experiences component can include an LLM.

In some embodiments, the dynamic experiences component 108 can include one or more functions and/or features. For example, the dynamic experiences component 108 can include a people explorer feature, a show similarities feature, a similarity scoring feature, cluster and recommendation creation feature, dynamic introductions feature, dynamic segmentations feature, match browsing feature, recommendation browsing feature, implicit and explicit feedback feature, sentiment scoring feature, among other features. Each feature of the dynamic experiences component 108 can be presented via a webpage accessed through a web browser, and/or presented via an executable application, among other means.

In some embodiments, the people explorer feature can include a user profile-based web browsing feature that shows users that are similar to any one or more of the users 120. The people explorer can show similar users based on interests, usage patterns, conversations, locations, among other user information and/or segmentation data, of the users 120. Each of the users 120 can explore and/or search through all the users 120 of the system 100 using the people explorer feature. The people explorer feature can be presented via a webpage accessed through a web browser, and/or presented via an executable application, among other means. In some examples, the users 120 can be listed and/or shown via a webpage of the people explorer feature. One or more user connections of the users 120 can be shown via the webpage.

In some embodiments, the show similarities feature can include an AI-based response feature that compares at least two users of the users 120, and shows similarities between the at least two users via their interests, system 100 usage patterns, user characteristics, and/or other user information that can be unique to each of the users 120 on the system 100. The AI-based response feature can include an LLM.

In some embodiments, the similarity scoring feature can include an algorithmic scoring feature (e.g., an AI-based algorithmic scoring feature) that can show the users 120 how similar the users are to each other. The AI-based algorithmic scoring feature can also be referred to as a similarity scoring algorithm. The AI-based algorithmic scoring feature can include an LLM. In some examples, data from each user profile of the users 120 can be used as input to the similarity scoring feature. The similarity scoring feature can connect and/or relate users 120 of the user networks 136 based on input received from the segmentation component 104 and automation component 106. In some examples, similarities between users 120 can be determined by the similarity scoring feature based on usage patterns in addition to segmentation data and/or user information gathered from the segmentation component 104 and automation component 106. In another embodiment, the similarity scoring feature can format, and/or present, e.g., via a webpage, similarities and/or comparison data determined from the segmentation component 104 and automation component 106.

In some embodiments, the cluster recommendation creation feature can provide recommendations of content, memberships, spaces (e.g., a system 100 navigation feature), and/or provide recommendations to connect with other users 120 and/or members. In some examples, the cluster recommendation creation feature can use AI and/or machine learning. The cluster recommendation creation feature can include an LLM. The cluster recommendation creation feature can perform user searches for a first order, a second order, a third order or more connection between the users 120. The cluster recommendation creation feature can perform user searches based user usage, user segmentation, user sentiment within the system 100, and/or perform user searches on profile fields of the user profiles. The searches performed by the cluster recommendation creation feature can go beyond a direct match, e.g., the searches performed via the cluster recommendation creation feature can be greater than first order connection searches.

In some embodiments, the dynamic introductions feature can include a combination of the similarity scoring and the cluster recommendations. In some examples, the dynamic introductions feature can be informed by the similarity scoring and the cluster recommendations. The subsystem 102, via the dynamic introductions feature, can automatically recommend double-opt-in introductions of relevant users of the users 120. Relevant users can include one or more users 120 that share user information and/or can support the growth of the user networks 136. Additionally, subsystem 102, via the subsystem 102, can automatically recommend conversation starters and/or introductions that the users 120 can use to interact with one another based on the similarities between users 120 generated from the user information.

The dynamic experiences component 108 can use the dynamic introductions feature to help make connections and/or introductions between the users 120. The dynamic introductions feature can include an LLM. The dynamic introductions feature can receive output from the similarity scoring feature and the cluster recommendation creation feature, format the output into a prompt, and input the prompt to a LLM. The LLM can be used to generate the conversation starters and/or introductions that the users 120 can use to interact with one another.

In some embodiments, the dynamic segmentations feature can run and/or support the people explorer feature. In some examples, the dynamic segmentations feature can be used to group users together, present similar users based on the grouping and/or dynamic segments that can be relevant to a particular user and/or group of users 120. The dynamic segmentations feature can be used to display relevant users 120 and/or user networks 136 to particular users 120 based on output from the people explorer feature.

In some embodiments, the match browsing feature can be similar to the people explorer feature. In some examples, the dynamic experiences component 108 can use the match browsing feature to share and/or showcase individual users 120 among one or more users 120 in the user networks 136 with the goal of making a connection and/or introduction between the users 120. In some examples, usage data of the users 120 within the system 100, user information, and/or segmentation data of the users 120 can be used to suggest connections, and/or matches between users 120. In some examples, the match browsing can input the usage data of the users 120 within the system 100 to an LLM. The LLM can generate conversation starters and/or introductions that the users having similar usage data can use to make connections.

In some embodiments, the recommendation browsing feature can be configured to recommended content to users 120, e.g., based on their user profiles and/or usage within the system 100. In some examples, the recommendation browsing can suggest real-world locations, real-world spaces, virtual spaces, real-world events, virtual events, online events, websites, posts, and among other recommendations to the users 120. The recommendation browsing feature can be configured to foster user engagement within the user networks 136 of the system 100. In some examples, the recommendation browsing feature can output from the segmentation component 104 and/or automation component 106, format the output into a prompt, input the prompt to an LLM to generate suggestions for real-world locations, real-world spaces, virtual spaces, real-world events, virtual events, online events, websites, posts, that the users 120 could be interested in.

In some embodiments, the implicit and explicit feedback feature can include implicit feedback feature. The implicit feedback feature can use AI algorithms and/or machine learning to match users 120, provide recommendations to users (e.g., dynamic experiences), and/or provide feedback to the users 120. The implicit feedback feature can be configured to inform a user 120 and/or hosts 110 recommendation browsing was successful in in driving user engagement. The implicit feedback feature can provide recommendations and/or provide feedback to users 120 based on user engagement statistics, among other data. In some embodiments, with each interaction with the hosts 110 and/or users 120, the system 100 and/or subsystem 102 can self-improve. In some examples, the system 100 and/or the subsystem 102 can incrementally improve on how matches, connections, recommendations, and/or dynamic experiences are performed for each of the users 120, e.g., using AI algorithms and/or machine learning. In some embodiments, the explicit feedback feature can be configured to provide prompts (e.g., notifications) to users following a match, connection, and/or a recommendation with another user. In some examples, a direct response between the users 120 can be used to inform whether a success of the interaction, and/or recommendation occurred. Similar to the implicit feedback feature, the explicit feedback feature can incrementally improve on how matches, connections, recommendations, and/or dynamic experiences are performed for each of the users 120, e.g., using AI algorithms and/or machine learning.

In some embodiments, the sentiment scoring feature can be configured to use sentiment in text received from users 120 to inform matching, connections, and/or recommendations between users 120. In some examples, the sentiment scoring feature can use large language models (LLM) to inform matching, connections, and/or recommendations between users 120. The sentiment scoring feature can be used in addition to determining user information, using segmentation data, and/or determining product system 100 usage, as described herein. In some embodiments, the sentiment scoring feature can include a LLM. In an example, the sentiment scoring feature can receive as input text such as conversations or interactions between the users 120, format the received text as a prompt indicating a request to inform matching, connections, and/or recommendations between the users 120, input the prompt to the LLM, and receive matching and connection recommendations from the LLM as output.

In some embodiments, the subsystem 102 of the system 100 can combine the segmentation component 104, automation component 106 and the dynamic experiences component 108 to automate user network engagement. The user network engagement performed in this way can be unique to each of the user networks 136. For example, the system 100 can collect data on each of the users 120 under their respective user networks. In some examples, the segmentation component 104 can cluster, segment, identify, and/or categorize users 120, and the automation component 106 can automatically assign the users 120 to corresponding user networks 136, e.g., any one or more of the user networks 128-134, based on the output from the segmentation component 104. The automation component 106 can be used to engage with the users 120 of the user networks 136, and the dynamic experiences component 108 can perform custom actions on behalf of the hosts 110, assign scores to the users 120, and/or provide navigation tailored to each of the users 120 of the user networks 136. The system 100 can collect user information of the users 120. In some examples, the user information can include intake user information and/or record user to user interactions. The user information can be recorded as profile fields and collected under user profiles corresponding to each of the users 120. The system 100 can assign the users 120 to their corresponding user networks 136 based on the user information. The system 100 can drive engagement within the user networks 136 in unique ways based on the user information. In one particular non-limiting example, the subsystem 102 can be used to (i) determine which users 120 have similar user information using the segmentation component 104, (ii) determine which of those users invited other users 120 to join similar user networks 136 using the automation component 106, and based on this determination (iii) introduce other users 120 with similar interests to join similar user networks 136. The introductions in this way can be set to be executed at a specific time, with a specific tone, and/or with a customized context optimized for the users 120 being brought together, e.g., using the segmentation dynamic experiences component 108.

### Methods for Automated User Network Curation

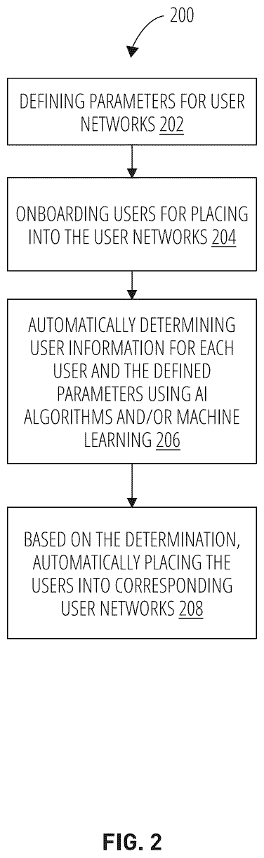

Referring to FIG. 2, a flowchart of a method for user network curation 200 is shown, according to some embodiments. In some embodiments, the method of 200 can be referred to as a people magic method, among other terms. In a step 202, the method can include defining parameters for user networks. In a step 204, the method can include onboarding users for placing them into the user networks. In a step 206, the method can include automatically determining user information for each user and the defined parameters using AI algorithms and/or machine learning. In some examples, step 206 can include using the AI algorithms and/or machine learning to cluster the most relevant users to each other and determine similarities between users for placing each of the users into their respective user networks. In a step 208, the method can include, based on the determination, automatically placing the users into corresponding user networks.

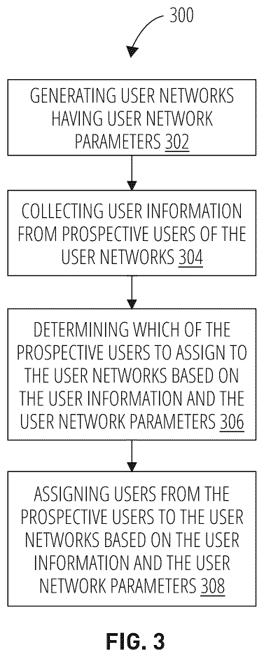

Referring to FIG. 3, a flowchart of a method 300 for user network curation is shown, according to some embodiments. In a step 302, the method can include generating user networks having user network parameters. The parameters can also be referred to as frameworks, among other terms. In some examples, step 302 can include receiving instructions from hosts of the user networks, and generating the parameters based on the instructions from the hosts. The instructions can include prompts that can be submitted to AI algorithms of the subsystem 102. The AI algorithms can be used to receive the prompts and generate the user networks and user network parameters based on the prompts. The AI algorithms can include Machine Learning (ML) models, Large Language Models (LLMs), among others. In one example, step 302 is optional, and the parameters can instead be pre-generated or pre-defined. In a step 304, the method can include collecting user information from prospective users of the user networks. The user information can include characteristics that describe the prospective users. In a step 306, the method can include determining which of the prospective users to assign to the user networks based on the user information and the user network parameters. Step 306 can include using AI algorithms to assign the users to the user networks. In some examples, step 306 can include using the AI algorithms to segment and/or cluster users based on the user information and parameters. Step 306 can include determining which users have characteristics that are most relevant for particular user networks. Step 306 can include determining similarities and/or differences between users. Step 306 can include using the segmentation component 104 to collect user information that describes the user's actions, behaviors and/or preferences. In a step 308, the method can include assigning users from the prospective users to the user networks based on the user information and the user network parameters.

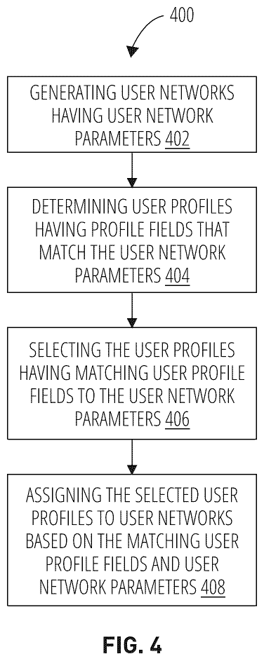

Referring to FIG. 4, a flowchart of a method 400 for user network curation is shown, according to some embodiments. In a step 402, the method can include generating user networks having user network parameters. In a step 404, the method can include determining user profiles having profile fields that match the user network parameters. In a step 406, the method can include selecting the user profiles having matching user profile fields to the user network parameters. In a step 408, the method can include assigning the selected user profiles to user networks based on the matching of user profile fields to the user network parameters.

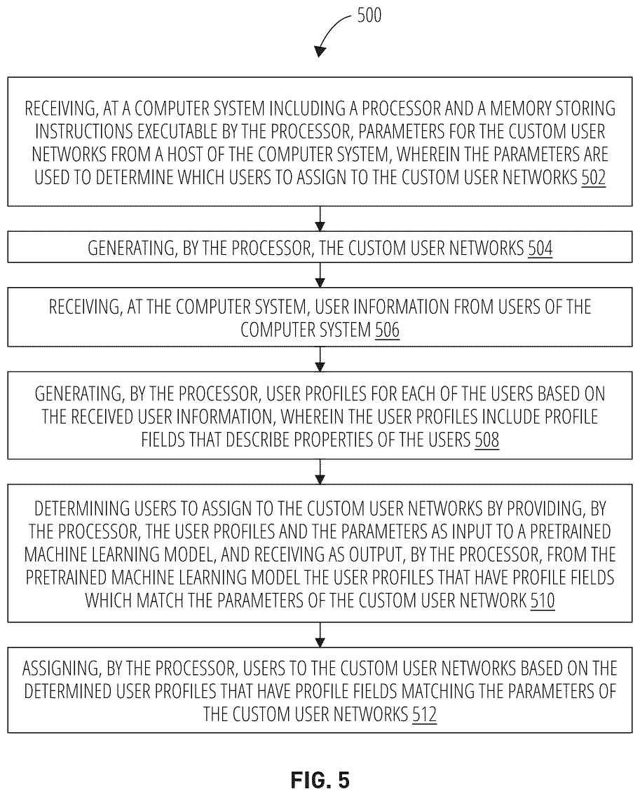

Referring to FIG. 5, a flowchart of a method 500 for automatic assignment of users to custom user networks is shown, according to some embodiments. In a step 502, the method can include receiving, at a computer system comprising a processor and a memory storing instructions executable by the processor, parameters for the custom user networks from a host of the computer system, where the parameters are used to determine which users to assign to the custom user networks In a step 504, the method can include generating, by the processor, the custom user networks. In a step 506, the method can include receiving, at the computer system, user information from users of the computer system. In a step 508, the method can include generating, by the processor, user profiles for each of the users based on the received user information, where the user profiles include profile fields that describe properties of the users. In a step 510, the method can include determining users to assign to the custom user networks by providing, by the processor, the user profiles and the parameters as input to a pretrained machine learning model, and receiving as output, by the processor, from the pretrained machine learning model the user profiles that have profile fields which match the parameters of the custom user network. In a step 512, the method can include assigning, by the processor, users to the custom user networks based on the determined user profiles that have profile fields matching the parameters of the custom user networks. In some embodiments, the subsystem 102 from FIG. 1 can perform the steps of 502-512. In one non-limiting example, the segmentation component 102 can perform steps 502-510, and the automation component 106 and/or the dynamic experiences component 108 can perform step 512.

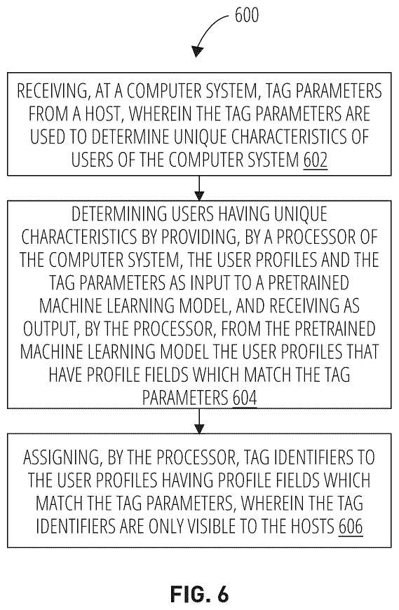

Referring to FIG. 6, a flowchart of a method 600 for assigning an identifier to a user profile is shown, according to some embodiments. In a step 602, the method can include receiving, at a computer system, tag parameters from the host, wherein the tag parameters are used to determine unique characteristics of the users of the computer system. In a step 604, the method can include determining users having unique characteristics by providing, by a processor of the computer system, the user profiles and the tag parameters as input to a pretrained machine learning model, and receiving as output, by the processor, from the pretrained machine learning model the user profiles that have profile fields which match the tag parameters. In a step 606, the method can include assigning, by the processor, tag identifiers to the user profiles having profile fields which match the tag parameters, wherein the tag identifiers are only visible to the hosts. In some embodiments, the method 600 can be combined with the method 500, e.g., the steps 602-606 can be performed subsequent to the step 512. In some embodiments, the subsystem 102 from FIG. 1 can perform the steps of 602-606. In one non-limiting example, the segmentation component 102 can perform steps 602 and 604, and the automation component 106 and/or the dynamic experiences component 108 can perform step 606.

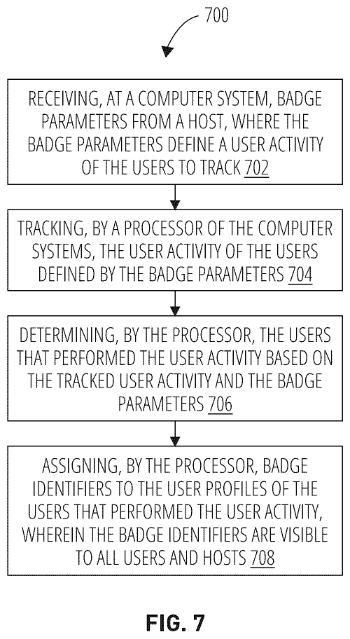

Referring to FIG. 7, a flowchart of a method 700 for assigning an identifier to a user profile is shown, according to some embodiments. In a step 702, the method can include receiving, at a computer system, badge parameters from the host, where the badge parameters define a user activity of the users to track. In a step 704, the method can include tracking, by a processor of the computer system, the user activity of the users defined by the badge parameters. In a step 706, the method can include determining, by the processor, the users that performed the user activity based on the tracked user activity and the badge parameters. In a step 708, the method can include assigning, by the processor, badge identifiers to the user profiles of the users that performed the user activity, wherein the badge identifiers are visible to all users and hosts. In some embodiments, the method 700 can be combined with the method 500, e.g., the steps 702-708 can be performed subsequent to the step 512. In some embodiments, the subsystem 102 from FIG. 1 can perform the steps of 702-708. In one non-limiting example, the segmentation component 102 can perform steps 702-706, and the automation component 106 and/or the dynamic experiences component 108 can perform step 708.

### Hardware and Software Implementations

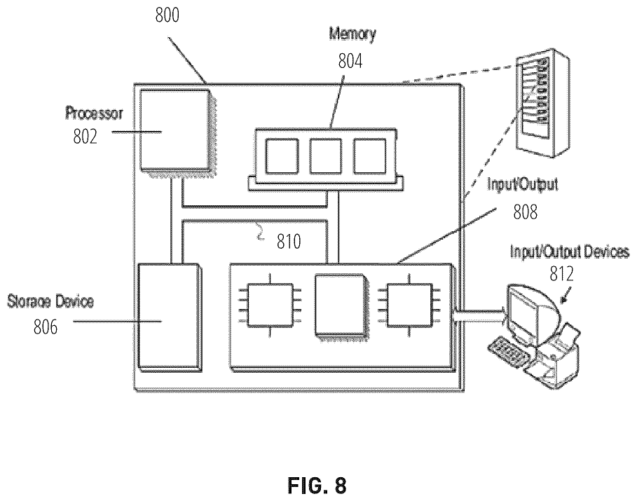

FIG. 8 is a block diagram of an example computer system 800 that may be used in implementing the technology described in this document. General-purpose computers, network appliances, mobile devices, or other electronic systems may also include at least portions of the system 800. The system 800 includes a processor 802, a memory 804, a storage device 806, and an input/output device 808. Each of the components 802, 804, 806, and 808 may be interconnected, for example, using a system bus 810. The processor 802 is capable of processing instructions for execution within the system 800. In some implementations, the processor 802 is a single-threaded processor. In some implementations, the processor 802 is a multi-threaded processor. The processor 802 is capable of processing instructions stored in the memory 804 or on the storage device 806.

The memory 804 stores information within the system 800. In some implementations, the memory 804 is a non-transitory computer-readable medium. In some implementations, the memory 804 is a volatile memory unit. In some implementations, the memory 804 is a non-volatile memory unit.

The storage device 806 is capable of providing mass storage for the system 800. In some implementations, the storage device 806 is a non-transitory computer-readable medium. In various different implementations, the storage device 806 may include, for example, a hard disk device, an optical disk device, a solid-date drive, a flash drive, or some other large capacity storage device. For example, the storage device may store long-term data (e.g., database data, file system data, etc.). The input/output device 808 provides input/output operations for the system 800. In some implementations, the input/output device 808 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 812. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 806 may be implemented in a distributed way over a network, for example as a server farm or a set of widely distributed servers, or may be implemented in a single computing device.

Although an example processing system has been described in FIG. 8, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; and magneto optical disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention.

What is claimed is:

1. A method for automatic assignment of users to custom user networks, the method comprising:
receiving, at a computer system comprising a processor and a memory storing instructions executable by the processor, parameters for the custom user networks from a host of the computer system, wherein the parameters are used to determine which users to assign to the custom user networks;
generating, by the processor, the custom user networks;
receiving, at the computer system, user information from users of the computer system;
generating, by the processor, user profiles for each of the users based on the received user information, wherein the user profiles include profile fields that describe properties of the users;
determining users to assign to the custom user networks by providing, by the processor, the user profiles and the parameters as input to a pretrained machine learning model, and receiving as output, by the processor, from the pretrained machine learning model the user profiles that have profile fields which match the parameters of the custom user network; and
assigning, by the processor, users to the custom user networks based on the determined user profiles that have profile fields matching the parameters of the custom user networks.

2. The method of claim 1, wherein the profile fields comprise at least one of a user's skills, a user's name, a user's birthday, a user's age, a user's address, a user's occupation, a user's specialization, a user's education, or a user's certifications.

3. The method of claim 1, wherein receiving user information from the users comprises receiving, at the computer system, user information as prompts to a large language model (LLM).

4. The method of claim 1, wherein generating, by the processor, user profiles for each of the users based on the collected user information comprises generating, by the processor, a structured dataset for each of the users that includes the user information associated with each user.

5. The method of claim 1, wherein generating, by the processor, user profiles for each of the users based on the collected user information comprises using a LLM to generate the user profiles based on the collected user information received from the users as a prompt.

6. The method of claim 1, wherein receiving, by the computer system, parameters for custom user networks from the host comprises receiving, at the computer system, keywords used to determine which users to assign to the custom user networks.

7. The method of claim 1, wherein receiving, by the computer system, parameters for custom user networks from the host comprises receiving, by the computer system, parameters as prompts to a LLM.

8. The method of claim 1, wherein determining users to assign to the custom user networks comprises the pretrained machine learning model clustering and segmenting the user profiles based on their corresponding profile fields and the parameters of the custom user networks.

9. The method of claim 1, wherein assigning the users to the custom user networks comprises using a LLM to automatically assign users to the custom user networks based on the determined user profiles that have profile fields matching the parameters of the custom user networks.

10. The method of claim 1, further comprising:
receiving, at the computer system, tag parameters from the host, wherein the tag parameters define unique characteristics of the users;
determining users having the unique characteristics by providing, by the processor, the user profiles and the tag parameters as input to a pretrained machine learning model, and receiving as output, by the processor, from the pretrained machine learning model the user profiles that have profile fields which match the tag parameters; and
assigning, by the processor, tag identifiers to the user profiles having profile fields which match the tag parameters, wherein the tag identifiers are only visible to the hosts.

11. The method of claim 1, further comprising:
receiving, at the computer system, badge parameters from the host, wherein the badge parameters define a user activity of the users to track;
tracking, by the processor, the user activity of the users defined by the badge parameters;
determining, by the processor, the users that performed the user activity based on the tracked user activity and the badge parameters; and
assigning, by the processor, badge identifiers to the user profiles of the users that performed the user activity, wherein the badge identifiers are visible to all users and hosts.

12. A computer-implemented method, the method comprising:
collecting user information from users of a plurality of user networks;
generating user profiles for each of the users based on the collected user information;
receiving user network parameters from hosts, wherein the user network parameters include attributes that describe at least one user network of the plurality of user networks;
selecting at least one user profile that has profile fields that match the attributes of the user network parameters; and
assigning at least one user to the at least one user network based on the selected user profile that matches the user network parameters.

13. The method of claim 12, wherein collecting user information comprises collecting at least one of a user's skills, a user's name, a user's birthday, a user's age, a user's address, a user's occupation, a user's specialization, a user's education, or a user's certifications.

14. The method of claim 12, wherein collecting user information from users comprises receiving user information as prompts to a LLM.

15. The method of claim 12, wherein generating user profiles for each of the users based on the collected user information comprises generating a structured dataset for each of the users that includes the user information associated with each user.

16. A system, the system comprising:
a segmentation component that (i) receives instructions from a host of the system, wherein the instructions include parameters for users networks of the system, (ii) receives user information from users of the user networks, (iii) generates user profiles having profile fields for each of the users based on the collected user information, and (iv) determines which users to assign to the user networks based on the profile fields which match the received parameters for users networks;
an automation component that assigns users to the user networks based on the determined user profiles that have profile fields which match the parameters of the user networks; and
a dynamic experiences component that presents the users with their respective assigned user networks.

17. The system of claim 16, wherein the user information comprises at least one of a user's skills, a user's preferences, a user's name, a user's birthday, a user's age, a user's address, a user's occupation, a user's specialization, a user's education, or a user's certifications.

18. The system of claim 16, wherein the segmentation component determines users to assign to the user networks by providing the user profiles and the parameters as input to a pretrained machine learning model, and receives as output from the pretrained machine learning model the user profiles that have profile fields which match the parameters of the user networks.

19. The system of claim 16, wherein the automation component includes a LLM that assigns users to the user networks based on the determined user profiles that have profile fields which match the parameters of the user networks.

20. The system of claim 16, wherein the dynamic experiences component includes a LLM that presents the users with their respective assigned user networks.
